(19) United States
(12) Patent Application Publication
(10) Pub. No.: US 2026/0138354 A1
(43) Pub. Date: May 21, 2026

(54) CLAD COMPOSITES, ARTICLES FORMED FROM CLAD COMPOSITES, METHODS OF FORMING CLAD COMPOSITES, AND METHODS OF FORMING ARTICLES

(71) Applicant: ARCONIC TECHNOLOGIES LLC, PITTSBURGH, PA (US)

(72) Inventors: Harry R. ZONKER, Oakmont, PA (US); David A. STARLING, South Lyon, MI (US); Ryan J. MIRANDA, Lancaster, PA (US)

(21) Appl. No.: 19/119,627

(22) PCT Filed: Nov. 10, 2023
(86) PCT No.: PCT/US2023/079357

§ 371 Date: Apr. 9, 2025

Related U.S. Application Data
(60) Provisional application No. 63/383,373, filed on Nov. 11, 2022.

(51) Int. Cl. B32B 15/01; C22C 21/00; F28F 21/08

(52) U.S. Cl. CPC B32B 15/016; C22C 21/00; F28F 21/089; B32B 2250/02; B32B 2311/24

(57) ABSTRACT

Clad composites, articles formed from clad composites, methods of forming clad composites, and methods of forming articles are provided. The clad composite comprises a core layer and a first layer. The core layer comprises a first aluminum alloy having a first corrosion potential. The first layer comprises a second aluminum alloy having a second corrosion potential. The second aluminum alloy comprises, in weight percentage, 0 to 0.5 Zn. The second corrosion potential is in a range of −600 mV to −800 mV. The first corrosion potential is less electronegative than the second corrosion potential by at least 8 mV and by no more than 100 mV.

### FIELD OF USE

The present disclosure relates to clad composites, articles formed from clad composites, methods of forming clad composites, and methods of forming articles.

### BACKGROUND

Various apparatus, such as, for example, heat exchangers may be formed from tubes and fins. Heat exchangers function by circulating fluid within the tubes and allowing heat exchange through the fins into the surrounding environment. To ensure that heat exchangers have an acceptable operational life, the heat exchanger may be designed to resist corrosion attack. Increasing the resistance to corrosion attack in heat exchangers can present significant challenges.

### SUMMARY

One non-limiting aspect according to the present disclosure is directed to a clad composite comprising a core layer and a first layer. The core layer comprises a first aluminum alloy having a first corrosion potential. The first layer comprises a second aluminum alloy having a second corrosion potential. The second aluminum alloy comprises, in weight percentage, 0 to 0.5 Zn. The second corrosion potential is in a range of −600 mV to −800 mV. The first corrosion potential is less electronegative than the second corrosion potential by at least 8 mV and by no more than 100 mV.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawing, wherein:

FIG. 1 is a schematic side elevational view of a non-limiting embodiment of a clad composite according to the present disclosure;

FIG. 2 is a schematic side elevational view of a non-limiting embodiment of a clad composite according to the present disclosure;

FIG. 3 is a schematic side elevational view of a non-limiting embodiment of an article comprising a clad composite according to the present disclosure;

FIG. 4 is a block diagram of a non-limiting embodiment of a method according to the present disclosure for forming a clad composite and an article from the clad composite;

FIG. 5 is a schematic perspective view of a tube comprising a non-limiting embodiment of a clad composite according to the present disclosure; and

FIG. 6 is a schematic perspective view of a heat exchanger comprising tubes comprising non-limiting embodiments of clad composites according to the present disclosure.

The exemplifications set out herein illustrate certain embodiments, in one form, and such exemplifications are not to be construed as limiting the scope of the appended claims in any manner.

### DETAILED DESCRIPTION

Various embodiments are described and illustrated herein to provide an overall understanding of the structure, function, and use of the disclosed articles and methods. The various embodiments described and illustrated herein are non-limiting and non-exhaustive. Thus, an invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, the applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various non-limiting embodiments”, “some non-limiting embodiments”, “one non-limiting embodiment”, “a non-limiting embodiment”, or like phrases mean that a particular feature, structure, or characteristic described in connection with the example is included in at least one embodiment. Thus, appearances of the phrases “in various non-limiting embodiments”, “in some non-limiting embodiments”, “in one non-limiting embodiment”, “in a non-limiting embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one non-limiting embodiment may be combined, in whole or in part, with the features, structures, or characteristics of one or more other non-limiting embodiments without limitation. Such modifications and variations are intended to be included within the scope of the present non-limiting embodiments.

Various non-limiting embodiments of alloys discussed in connection with the present disclosure optionally include intentional additions of incidental elements that may, for example, aid in production of the alloy and/or improve one or more properties or characteristics of the alloy. For example, certain non-limiting embodiments of alloys according to the present disclosure may include intentional incidental additions of one or more of grain refining elements and/or one or more deoxidizing elements. In various non-limiting embodiments, the total concentration of incidental elements in alloys according to the present disclosure preferably does not exceed 1 weight percent based on the total weight of the alloy, and the concentration of any single incidental element preferably does not exceed 0.2 weight percent based on the total weight of the alloy.

Various non-limiting embodiments of alloys discussed in connection with the present disclosure may include impurities. As used herein, “impurities” are elements or other materials that may be present in relatively minor concentrations in alloys according to the present disclosure but that are not intentionally added to enhance production or affect properties or characteristics of the alloy. For example, impurities in the alloys according to the present disclosure may be present in minor concentrations due to, for example, unavoidable or unintentional presence of the impurities in feed materials, incorporation from the local atmosphere during melting and refining, or contamination by contact with processing equipment. In various non-limiting embodiments, the total concentration of impurities in alloys discussed in the present disclosure preferably does not exceed 0.15 weight percent based on the total weight of the alloy, and the concentration of any single impurity preferably does not exceed 0.05 weight percent based on the total weight of the alloy.

Clad composites can be susceptible to galvanic corrosion due to a galvanic difference between the composition of the clad composites and the composition of a material that is coupled to (e.g., galvanically coupled to) the clad composites. As used herein, “galvanic difference” means a corrosion potential difference (e.g., a corrosion potential difference) between one region (e.g., layer) and another region. The corrosion potential difference between the regions can be due to a difference in the compositions of the regions. Without being bound to a particular mechanism or theory, in some non-limiting embodiments, when two regions having a corrosion potential difference are coupled together and are in the presence of an electrolyte, one region will act as the anode of a galvanic circuit, while the other region will act as the cathode of the galvanic circuit. As used herein, “anodic” or “anode” refers to a region having a composition that is more electronegative than another region. As used herein, “cathodic” or “cathode” refers to a region having a composition that is less electronegative than another region. As used herein, “more electronegative” means that a corrosion potential value is more negative than another corrosion potential value (e.g., a corrosion potential value of −900 mV is more electronegative than a corrosion potential value of −740 my). Also as used herein, “less electronegative” means that a corrosion potential value is more positive than another corrosion potential value (e.g., a corrosion potential value of −740 mV is less electronegative than a corrosion potential value of −900 mV). Corrosion potential may be measured according to ASTM G69-20.

To improve the corrosion resistance of clad composites and thereby increase the operational life of articles comprising the clad composites, the present disclosure provides novel clad composites, articles formed from clad composites, methods of forming clad composites, and methods of forming articles. Embodiments of clad composites according to the present disclosure comprise a core layer and a first layer. The core layer comprises a first aluminum alloy having a first corrosion potential. The first layer comprises a second aluminum alloy having a second corrosion potential. The second corrosion potential is in a range of −600 mV to −800 mV. The first corrosion potential is less electronegative than the second corrosion potential by at least 8 mV and by no more than 100 mV.

As used herein, the term “core” or “core layer” refers to a substrate layer of the clad composite. In various non-limiting embodiments, the “core layer” can be disposed substantially in the center of a clad composite. However, the position of the core layer in a clad composite according to the present disclosure is not limited to the center of a clad composite. The core layer may or may not be covered on both of its faces with another layer of the clad composite and, for example, the core layer can be disposed on one side of the clad composite. Accordingly, in various non-limiting embodiments, the core layer can be surrounded by other layers of the clad composite, have at least one side partially exposed, or have at least one side fully exposed.

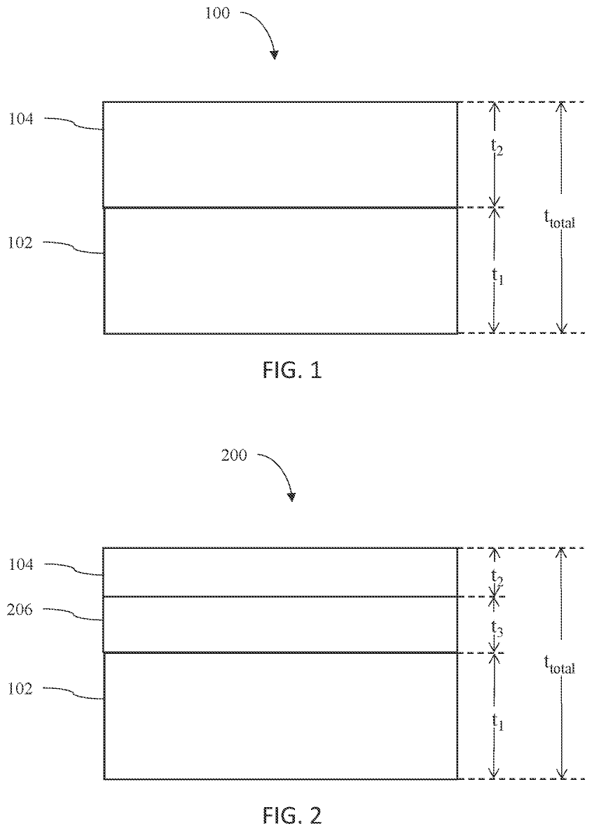

Referring to FIG. 1, a clad composite 100 according to the present disclosure is provided. The clad composite 100 comprises a core layer 102 and a first layer 104, which can be disposed on the core layer 102. In various non-limiting embodiments, referring to FIG. 1, the core layer 102 and the first layer 104 are bonded together in the clad composite 100 and can be in contact with one another. Again referring to FIG. 2, optionally, in certain non-limiting embodiments, a clad composite 200 according to the present disclosure can comprise the core layer 102, the first layer 104, and a second layer 106 disposed intermediate the core layer 102 and the first layer 104. In various non-limiting embodiments, referring to FIG. 2, the core layer 102, the first layer 104, and the second layer 106 are bonded together in the clad composite 200, and the second layer 106 can be in contact with the core layer 102 and the first layer 104. In certain non-limiting embodiments, a clad composite 100 may comprise layers in addition to the core layer 102, the first layer 104, and the second layer 106.

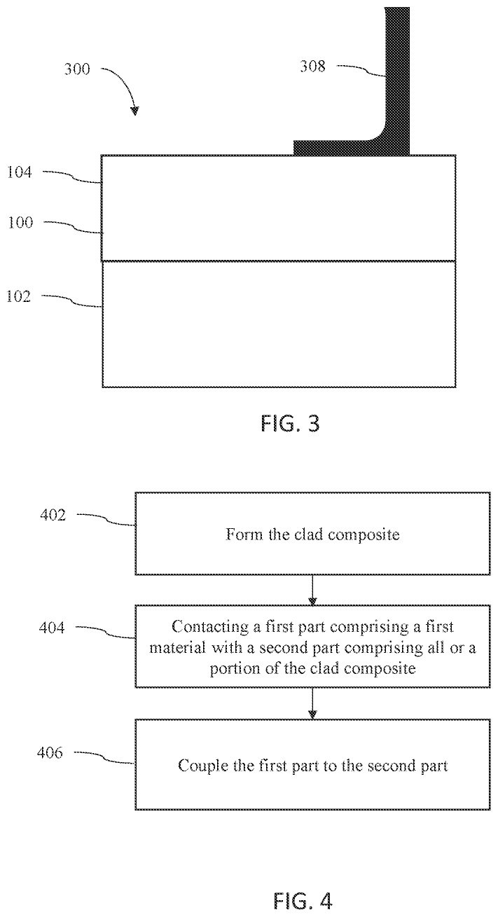

Referring to FIG. 3, an article 300 can comprise the clad composite 100 and/or clad composite 200 (not shown) coupled to a second material, such as, for example, a fin 308. The fin 308 may comprise a 1XXX series aluminum alloy or a 3XXX series aluminum alloy, each such aluminum alloy comprising, in weight percentages, no greater than 0.25 Zn, such as, for example, no greater than 0.2 Zn, no greater than 0.15 Zn, no greater than 0.1 Zn, no greater than 0.05 Zn, or no greater than 0.01 Zn. The minor concentration of Zn can enable more efficient recycling of the fin and/or use of varying grades of aluminum alloys. In some previous examples, relatively large additions of Zn were included in fins to increase corrosion potential of the fins and increase self-corrosion resistance of the fins.

In various non-limiting embodiments, due to the minor concentration of Zn in the fin, the corrosion potential of the fin 308 may not be as electronegative as desired and such that the fin 308 is anodic relative to the clad composite 100, 200. For example, the fin 308 may have a corrosion potential in a range of −740 millivolts (mV) to −900 mV, such as, for example, −740 mV to −850 mV, −740 mV to −800 mV, or −740 mV to −780 mV. Typically, fins for corrosion resistance have a corrosion potential significantly greater than −900 mV, such that layers having a corrosion potential value more electronegative than −800 mV (e.g., −850 mV) are still cathodic relative to the fins.

To enhance the corrosion resistance of the clad composite 100, 200, the corrosion potentials of the layers within the clad composite 100 can be selected to achieve a desirable corrosion resistance. For example, the clad composite 100 can be cathodic relative to the fin 308 in a galvanic circuit such that the fin 308 preferentially corrodes. In various non-limiting embodiments, a large corrosion potential difference between the fin 308 and the clad composite 100, 200 may lead to rapid corrosion of the fin 308, and the fin 308 may have undesirable self-corrosion resistance due to, for example, a low concentration or lack of Zn. The corrosion potential of the clad composite 100, 200 can be selected based on the corrosion potential of the fin 308 such that the fin 308 preferentially corrodes at a suitable rate.

Referring to FIGS. 1-3, the core layer 102 comprises a first aluminum alloy having a first corrosion potential, and the first layer 104 comprises a second aluminum alloy having a second corrosion potential. In various non-limiting embodiments, the first corrosion potential is less electronegative than the second corrosion potential in order to achieve a galvanic gradient from the first layer 104 to the core layer 102. For example, the first corrosion potential can be less electronegative than the second corrosion potential by at least 8 mV, such as, for example, by at least 10 mV, at least 20 mV, at least 30 mV, or at least 40 mV. The first corrosion potential can be less electronegative than the second corrosion potential by no more than 100 mV, such as, for example, no more than 90 mV, no more than 80 mV, no more than 70 mV, no more than 60 mV, no more than 50 mV, no more than 40 mV, or no more than 30 mV.

The second corrosion potential can be selected based on the desired application, such as, for example, if the clad composite 100, 200 will be attached to the fin 308. For example, in various non-limiting embodiments, the second corrosion potential can be in a range of −600 mV to −800 mV, such as, for example, −680 mV to −740 mV, −690 mV to −730 mV, −700 mV to −730 mV, −715 mV to −730 mV, or −720 mV to 730 mV. In various non-limiting embodiments, the first corrosion potential can be in a range of −590 mV to −750 mV, such as, for example, −620 mV to −730 mV, −630 mV to 720 mV, −650 mV to −720 mV, −690 mV to −720 mV, −690 mV to −710 mV, or −695 mV to less than 720 mV.

Referring to FIG. 2, the second layer 106 comprises a third aluminum alloy having a third corrosion potential. The third corrosion potential can be selected to be more electronegative than the first corrosion potential and less electronegative than the second corrosion potential. In various non-limiting embodiments, regardless of the number of layers in the clad composite 100, a gradient of galvanic potential can be configured within the clad composite 100 in which the core layer 102 is the most cathodic of the layers and the first layer 104 is the most anodic of the layers. In various non-limiting embodiments, the third corrosion potential can be in a range of −600 mV to −800 mV, such as, for example, −680 mV to −740 mV, −690 mV to −730 mV, −700 mV to −730 mV, or −715 mV to −730 mV.

Referring again to FIGS. 1-3, in order to configure the galvanic circuit within the clad composite 100, the core layer 102 comprises a first concentration of a first cathodic material, the first layer 104 comprises a second concentration of a second cathodic material, and the second layer 106 comprises a third concentration of a third cathodic material. The first concentration can be greater than the second concentration. The third concentration can be greater than the second concentration and less than the first concentration. As used herein, a “cathodic material” may be an element or a combination of elements that can make the corrosion potential of the respective layer more electronegative when present in the layer.

The first cathodic material, the second cathodic material, and the third cathodic material can be the same or different and in various non-limiting embodiments are each individually selected from the group consisting of Cu, Mg, Mn, Si, Fe, Cr, Ti, Zr, V, Li, and combinations of two or more thereof. In various examples, the first cathodic material, the second cathodic material, and the third cathodic material can be the same in order to limit interdiffusion between the layers in the brazing sheet during a brazing cycle. In various non-limiting embodiments, the first cathodic material, the second cathodic material, and the third cathodic material are individually selected from the group consisting of Cu, Zn, and Mg. In various non-limiting embodiments, the first cathodic material, the second cathodic material, and the third cathodic material are a mixture of at least two elements individually selected from the group consisting of Cu, Zn, Mg, Mn, Si, Fe, Cr, Ti, Zr, V, and Li.

In certain non-limiting embodiments, the first cathodic material, the second cathodic material, and the third cathodic material are Cu. Cu can make the corrosion potential of a respective layer less electronegative and provide solution strengthening to the respective layer. In various non-limiting embodiments, the copper concentration may be limited to 1% by weight or less to inhibit precipitation, which can adversely impact self-corrosion resistance of the respective layer.

In various non-limiting embodiments, the first concentration can be greater than the second concentration by at least 0.1 weight percent, such as, for example, by at least 0.15 weight percent, by at least 0.2 weight percent, or by at least 0.25 weight percent. In various non-limiting embodiments, the second concentration can be greater than the third concentration by at least 0.05 weight percent, such as, for example, by at least 0.1 weight percent, by at least 0.15 weight percent, or by at least 0.2 weight percent. In various non-limiting embodiments, the core layer 102 comprises at least 0.5 weight percent of the first cathodic material. In various non-limiting embodiments in which the first cathodic material, the second cathodic material, and third cathodic material are Cu, the first concentration can be in a range of 0.5 to 1 weight percent Cu, the second concentration can be in a range of 0.25 to 0.5 weight percent Cu, and the third concentration can be in a range of 0.3 to 0.7 weight percent Cu. In various non-limiting embodiments, starting with the core layer 102 and advancing through the thickness of the clad composite 100 toward the first layer 104, the concentration of the cathodic material increases with each subsequent layer.

Again referring to FIGS. 1-3, the core layer 102 of the clad composite 100, 200 comprises the first aluminum alloy, which can be, for example, a 1XXX series aluminum alloy, a 3XXX series aluminum alloy, a 5XXX series aluminum alloy, or a 6XXX series aluminum alloy. In various non-limiting embodiments, the first aluminum alloy comprises, in weight percentages: 0.05 to 1.5 Si; 0 to 0.8 Fe; 0.5 to 1.0 Cu; 0.5 to 1.8 Mn; 0 to 0.2 Mg; 0 to 0.25 Zn; 0 to 0.25 Cr; 0 to 0.15 Zr; aluminum; optionally, incidental elements; and impurities. In some non-limiting embodiments, the first aluminum alloy comprises, in weight percentages: 0.05 to 0.95 Si; 0 to 0.8 Fe; 0.7 to 1.0 Cu; 1.25 to 1.8 Mn; 0 to 0.15 Mg; 0 to 0.15 Zn; 0 to 0.15 Cr; 0 to 0.1 Zr; aluminum; optionally, incidental elements; and impurities.

Referring yet again to FIGS. 1-3, the first layer 104 of the clad composite 100, 200 comprises the second aluminum alloy, which can be, for example, a 1XXX series aluminum alloy or a 3XXX series aluminum alloy. In various non-limiting embodiments, the second aluminum alloy comprises, in weight percentages: 0.05 to 1.0 Si; 0.25 to 0.5 Cu; 0 to 0.5 Zr; 0 to 0.8 Fe; 0.1 to 1.5 Mn; 0 to 0.25 Zn; 0 to 0.2 Mg; 0 to 0.2 Ti; 0 to 1 Cr; 0 to 0.5 Bi; aluminum; optionally, incidental elements; and impurities. In various non-limiting embodiments, the second aluminum alloy comprises, in weight percentages: 0.05 to 1.0 Si; 0.25 to 0.5 Cu; 0 to 0.5 Zr; 0 to 0.8 Fe; 0.1 to 1.5 Mn; 0 to 0.1 Zn; 0 to 0.1 Mg; 0 to 0.2 Ti; 0 to 1 Cr; 0 to 0.5 Bi; aluminum; optionally, incidental elements; and impurities. In various non-limiting embodiments, the second aluminum alloy comprises, in weight percentage, 0 to 0.5 Zn, such as, for example, 0 to 0.25 Zn, 0 to 0.1 Zn, or 0 to 0.5 Zn.

Referring to FIG. 2, the second layer 106 of the clad composite 200 comprises a third aluminum alloy, such as, for example, an aluminum alloy comprising, in weight percentages: 0.05 to 1.0 Si; 0.25 to 0.5 Cu; 0 to 0.5 Zr; 0 to 0.8 Fe; 0.1 to 1.5 Mn; 0 to 0.25 Zn; 0 to 0.2 Mg; 0 to 0.2 Ti; 0 to 1 Cr; 0 to 0.5 Bi; aluminum; optionally, incidental elements; and impurities.

Referring to FIGS. 1-2, the thickness of each layer in the clad composite 100 can be configured based on the desired structural properties of the article to be produced from or incorporating the clad composite 100. For example, in various non-limiting embodiments, the core layer 102 can comprise a first thickness, t₁, that can be in a range of 60% to 90% of a total thickness, i.e., tₜₒₜₐₗ, of the clad composite 100. In various non-limiting embodiments, the first layer 104 can comprise a second thickness, t₂, that is in a range of 3% to 20% of the total thickness (tₜₒₜₐₗ) of the clad composite 100. Referring to FIG. 2, in various non-limiting embodiments, the second layer 106, if present, can comprise a third thickness, t₃, that is in a range of 3% to 20% of a total thickness (tₜₒₜₐₗ) of the clad composite 100. In various non-limiting embodiments, the first thickness, t₁, is greater than the second thickness, t₂, and also is greater than the third thickness, t₃. In certain non-limiting embodiments, referring to FIGS. 1-2, the total thickness (tₜₒₜₐₗ) of the clad composite 100, 200 is in a range of 100 μm to 5 mm, such as, for example, in a range of 200 μm to 1 mm.

FIG. 4 is a block diagram of a non-limiting embodiment of a method according to the present disclosure for forming a clad composite according to the present disclosure and an article such as, for example, a heat exchanger, including the clad composite. In certain non-limiting embodiments, the method comprises forming the clad composite, such as clad composite 100, 200 (FIG. 4, step 402). For example, a non-limiting embodiment of the method can comprise casting the core layer 102, the first layer 104, and optionally, the second layer 106, utilizing a multi-layer casting method, hot working (e.g., hot rolling) an assembly including a sheet of the core layer 102, a sheet of the first layer 104, and optionally, a sheet of the second layer 106 to secure the layers together and form the clad composite 100, 200, or a combination of multi-layer casting and hot working.

Again referring to FIG. 4, the method further comprises, subsequent to forming the clad composite (e.g., clad composite 100, 200), contacting a first part comprising a first material with a second part comprising all or a portion of a non-limiting embodiment of the clad composite (FIG. 4, step 404). For example, a non-limiting embodiment of a method according to the present disclosure may comprise contacting a first part comprising a first material with a second part comprising all or a portion of the clad composite 100, 200. In various non-limiting embodiments, the first part can be coupled to the second part (FIG. 4, step 406). For example, the first part can be coupled to the second part by adhesive, welding, soldering, brazing, a mechanical joint, or a combination thereof. In various non-limiting embodiments, the first material comprises aluminum or an aluminum alloy, such as, for example, a 1XXX series aluminum alloy or a 3XXX series aluminum alloy.

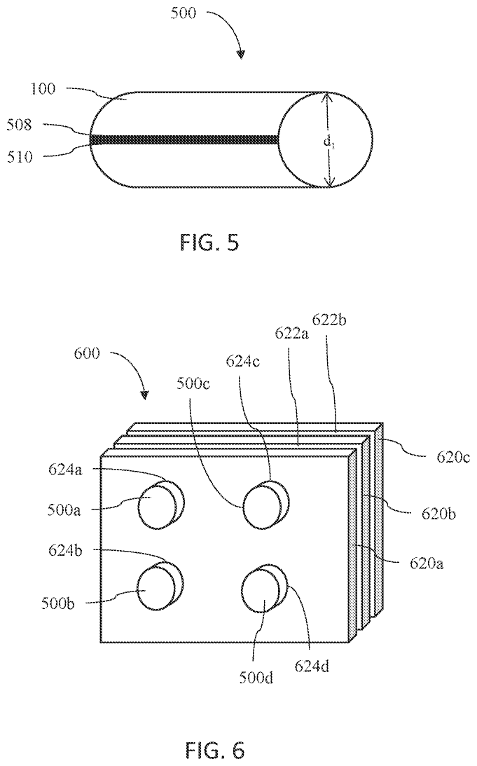

In various non-limiting embodiments according to the present disclosure, the clad composite (e.g., clad composite 100, 200) can have a composition and thickness suitable for forming into a tube. For example, referring to FIG. 5, the clad composite 100 or clad composite 200 can be formed into a tube 500. For example, the clad composite 100 can be bent such that a first end 508 of the clad composite 100 contacts a second end 510 of the clad composite 100 thereby forming a tube. The first end 508 and the second end 510 can be bonded together by, for example, an adhesive, welding, soldering, brazing, or a combination thereof. The outer diameter, di, of the tube can be in a range of 3 millimeters (mm) to 30 mm, such as, for example, 3 mm to 8 mm, or 5 mm to 7 mm.

In various non-limiting embodiments, an article such as, for example, a heat exchanger, can comprise a structural element comprising all or a portion of the clad composite 100, 200, such as, for example, all or a portion of the tube 500. The heat exchanger can have suitable galvanic corrosion resistance. The heat exchanger can be, for example, a portion of a heating, ventilation, and air conditioning (HVAC) system.

For example, referring to FIG. 6, the tube 500 can be a portion of a heat exchanger 600. As illustrated, the heat exchanger 600 comprises tubes 500a-500d and fins 620a-620d. The fins 620a-620d can be arranged in a stack with a gap 622a-622b intermediate each adjacent pair of fins 620a-620d. The widths of the gaps 622a-622b may be the same or different. In various non-limiting embodiments, gaps 622a-622b may not be present and adjacent fins can be in direct contact with one another. The fins 620a-620d may have bores 624a-624d extending therethrough, and the bores 624a-624d can receive tubes 500a-500d. The tubes 500a-500d can be coupled to the fins 620a-620c by, for example, an adhesive, welding, soldering, brazing, a mechanical joint (e.g., expanded into a friction fit with fins 620a-620c), or a combination thereof. The number of tubes 500a-500d, fins 620a-620d, and bores 624a-624d can vary based on the desired application.

### Examples

The present disclosure will be more fully understood by reference to the following examples, which illustrate certain non-limiting aspects of various embodiments according to the present disclosure.

Several aluminum alloy compositions were selected according to the present disclosure as listed in Table 1 below. The corrosion potential of each listed aluminum alloy composition was estimated using an internally created computer model.

TABLE 1
Aluminum Alloy Composition Examples and Estimated Corrosion potential

| | | | | | | | | Al and | Estimated |
|---|---|---|---|---|---|---|---|---|---|
| Alloy | Si | Fe | Cu | Mn | Mg | Zn | Ti | Incidental | Corrosion |
| Example | (wt %) | (wt %) | (wt %) | (wt %) | (wt %) | (wt %) | (wt %) | Impurities | potential |
| A | 0.40 | 0.30 | 0.75 | 1.50 | 0.100 | 0.10 | 0.130 | Balance | −716 |
| B | 0.40 | 0.30 | 0.90 | 1.50 | 0.100 | 0.10 | 0.130 | Balance | −711 |
| C | 0.40 | 0.30 | 0.90 | 1.50 | 0.04 | 0.10 | 0.130 | Balance | −711 |
| D | 0.40 | 0.50 | 0.90 | 1.50 | 0.100 | 0.10 | 0.130 | Balance | −713 |
| E | 0.88 | 0.18 | 0.85 | 1.65 | 0.03 | 0.03 | 0.125 | Balance | −698 |
| F | 0.275 | 0.55 | 0.40 | 1.10 | 0.03 | 0.05 | 0.03 | Balance | −724 |
| G | 0.10 | 0.21 | 0.40 | 0.30 | 0.03 | 0.05 | 0.03 | Balance | −722 |

Using the aluminum alloy compositions A-G listed in Table 1, several clad composites were modeled. Several two-layer clad composites, Examples 1-10, were modeled to include a 100 μm thick first layer and a 600 μm thick core layer. A three-layer clad composite, Example 11, was modeled to include a 25 μm first layer, a 75 μm second layer, and a 600 μm core layer, with the second layer disposed intermediate the first layer and the core layer. After selected layers were virtually assembled, a brazing diffusion computer model was applied to the assembly to virtually bond together the layers and form a virtual clad composite, and the corrosion potential across the thickness of the clad composite was modeled. The calculated corrosion potential across the thickness of the clad composite was used to evaluate expected corrosion performance of the composite. The results are shown in Table 2 below:

TABLE 2
Clad Composite Examples

| Clad | Core | First | Second | Expected |
|---|---|---|---|---|
| Composite | Layer | Layer | Layer | Corrosion |
| Example | Alloy | Alloy | Alloy | Performance |
| 1 | A | F | None | Good |
| 2 | B | F | None | Good |
| 3 | C | F | None | Good |
| 4 | D | F | None | Good |
| 5 | E | F | None | Good |
| 6 | A | G | None | Good |
| 7 | B | G | None | Good |
| 8 | C | G | None | Good |
| 9 | D | G | None | Good |
| 10 | E | G | None | Good |
| 11 | E | G | A | Good |

As shown in Table 2, when the difference in corrosion potential between the first layer and the core layer is at least 8 mV, the corrosion performance of the clad composite was expected to be good based on the evaluation using the computer model. It is believed that other embodiments of clad composites according to the present disclosure also would exhibit good corrosion performance.

The following numbered clauses are directed to various non-limiting embodiments and aspects according to the present disclosure.

Clause 1. A clad composite comprising:
a core layer comprising a first aluminum alloy having a first corrosion potential; and
a first layer comprising a second aluminum alloy having a second corrosion potential;
wherein the second corrosion potential is in a range of −600 mV to −800 mV, and the first corrosion potential is less electronegative than the second corrosion potential by at least 8 mV and by no more than 100 mV.

Clause 2. The clad composite of Clause 1, wherein the first corrosion potential is no more than 50 mV less electronegative than the second corrosion potential.

Clause 3. The clad composite of any of Clauses 1-2, wherein the first corrosion potential is no more than 30 mV less electronegative than the second corrosion potential.

Clause 4. The clad composite of any of Clauses 1-3, wherein the second corrosion potential is in a range of −700 mV to −730 mV and the first corrosion potential is in a range of −650 mV to −720 mV.

Clause 5. The clad composite of any of Clauses 1-4, wherein the second corrosion potential is in a range of −715 mV to −730 mV and the first corrosion potential is in a range of −690 mV to −720 mV.

Clause 6. The clad composite of any of Clauses 1-5, wherein the first layer is disposed on the core layer.

Clause 7. The clad composite of any of Clauses 1-6, further comprising:
a second layer intermediate the core layer and the first layer, the second layer comprising an aluminum alloy having a third corrosion potential; and
wherein the third corrosion potential is less than the first corrosion potential and is greater than the second corrosion potential.

Clause 8. The clad composite of any of Clauses 1-7, wherein:
the core layer comprises a first concentration of a first cathodic material; and
the first layer comprises a second concentration of a second cathodic material, wherein the first concentration is greater than the second concentration.

Clause 9. The clad composite of Clause 8, wherein the first cathodic material and the second cathodic material comprise a material individually selected from the group consisting of Cu, Zn, Mg, Mn, Si, Fe, Cr, Ti, Zr, V, Li, and combinations of two or more thereof.

Clause 10. The clad composite of Clause 9, wherein the first cathodic material and the second cathodic material are Cu.

Clause 11. The clad composite of Clause 10, wherein the first concentration is greater than the second concentration by at least 0.1 weight percent.

Clause 12. The clad composite of any of Clauses 8-10, wherein the core layer comprises at least 0.5 weight percent of the first cathodic material.

Clause 13. The clad composite of any of Clauses 1-12, wherein:
the core layer comprises, in weight percentages, 0.5 to 1.0 Cu; and
the first layer comprises, in weight percentages, 0.25 to 0.5 Cu.

Clause 14. The clad composite of any of Clauses 1-13, wherein the core layer and the first layer are bonded together.

Clause 15. The clad composite of any of Clauses 1-14, wherein the second aluminum alloy comprises, in weight percentages: 0.05 to 1.0 Si; 0.25 to 0.5 Cu; 0 to 0.5 Zr; 0 to 0.8 Fe; 0.1 to 1.5 Mn; 0 to 0.25 Zn; 0 to 0.2 Mg; 0 to 0.2 Ti; 0 to 1 Cr; 0 to 0.5 Bi; aluminum; optionally, one or more incidental elements; and impurities.

Clause 16. The clad composite of any of Clauses 1-15, wherein the first aluminum alloy comprises, in weight percentages: 0.05 to 1.5 Si; 0 to 0.8 Fe; 0.5 to 1.0 Cu; 0.5 to 1.8 Mn; 0 to 0.2 Mg; 0 to 0.25 Zn; 0 to 0.25 Cr; 0 to 0.15 Zr; aluminum; optionally, one or more incidental elements; and impurities.

Clause 17. An article comprising:
the clad composite of any of Clauses 1-16; and
a fin coupled to the first layer of the clad composite, wherein the fin comprises a 1XXX series aluminum alloy or a 3XXX series aluminum alloy.

Clause 18. The article of Clause 17, wherein the fin has an corrosion potential in a range of −740 mV to −900 mV.

Clause 19. The article of any of Clauses 17-18, wherein the clad composite is tube shaped.

Clause 20. The article of any of Clauses 17-19, wherein the fin comprises no more than 0.25 Zn, in weight percent.

Clause 21. A heat exchanger comprising a structural element comprising all or a portion of the article of any of Clauses 17-20.

Clause 22. The heat exchanger of Clause 21, wherein the heat exchanger is part of a heating, ventilation, and air conditioning system.

Clause 23. A method for forming an article, the method comprising:
contacting a first part comprising a first material with a second part comprising all or a portion of a clad composite of any of Clauses 1-22; and
coupling the first part to the second part.

Clause 24. The method of Clause 23, wherein the first material comprises a 1XXX series aluminum alloy or a 3XXX series aluminum alloy.

Clause 25. The method of any of Clauses 23-24, wherein the article is a heat exchanger.

Clause 26. The method of Clause 25, wherein the heat exchanger is part of a heating, ventilation, and air conditioning system.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

1. A clad composite comprising:
a core layer comprising a first aluminum alloy having a first corrosion potential; and
a first layer comprising a second aluminum alloy having a second corrosion potential, wherein the second aluminum alloy comprises, in weight percentage, 0 to 0.5 Zn;
wherein the second corrosion potential is in a range of −600 mV to −800 mV, and the first corrosion potential is less electronegative than the second corrosion potential by at least 8 mV and by no more than 100 mV.

2. The clad composite of claim 1, wherein the first corrosion potential is no more than 50 mV less electronegative than the second corrosion potential.

3. The clad composite of claim 1, wherein the first corrosion potential is no more than 30 mV less electronegative than the second corrosion potential.

4. The clad composite of claim 1, wherein the second corrosion potential is in a range of −700 mV to −730 mV and the first corrosion potential is in a range of −650 mV to −720 mV.

5. The clad composite of claim 1, wherein the second corrosion potential is in a range of −715 mV to −730 mV and the first corrosion potential is in a range of −690 mV to −720 mV.

6. The clad composite of claim 1, wherein the first layer is disposed on the core layer.

7. The clad composite of claim 1, further comprising:
a second layer intermediate the core layer and the first layer, the second layer comprising an aluminum alloy having a third corrosion potential; and
wherein the third corrosion potential is less than the first corrosion potential and is greater than the second corrosion potential.

8. The clad composite of claim 1, wherein
the core layer comprises a first concentration of a first cathodic material; and
the first layer comprises a second concentration of a second cathodic material;
wherein the first concentration is greater than the second concentration.

9. The clad composite of claim 8, wherein the first cathodic material and the second cathodic material comprise a material individually selected from the group consisting of Cu, Zn, Mg, Mn, Si, Fe, Cr, Ti, Zr, V, Li, and combinations of two or more thereof.

10. The clad composite of claim 9, wherein the first cathodic material and the second cathodic material are Cu.

11. The clad composite of claim 10, wherein the first concentration is greater than the second concentration by at least 0.1 weight percent.

12. The clad composite of claim 8, wherein the core layer comprises at least 0.5 weight percent of the first cathodic material.

13. The clad composite of claim 1, wherein:
the core layer comprises, in weight percentages, 0.5 to 1.0 Cu; and
the first layer comprises, in weight percentages, 0.25 to 0.5 Cu.

14. The clad composite of claim 1, wherein the core layer and the first layer are bonded together.

15. The clad composite of claim 1, wherein the second aluminum alloy comprises, in weight percentages:
0.05 to 1.0 Si;
0.25 to 0.5 Cu;
0 to 0.5 Zr;
0 to 0.8 Fe;
0.1 to 1.5 Mn;
0 to 0.25 Zn;
0 to 0.2 Mg;
0 to 0.2 Ti;
0 to 1 Cr,
0 to 0.5 Bi;
aluminum;
optionally, one or more incidental elements; and
impurities.

16. The clad composite of claim 1, wherein the first aluminum alloy comprises, in weight percentages:
0.05 to 1.5 Si;
0 to 0.8 Fe;
0.5 to 1.0 Cu;
0.5 to 1.8 Mn;
0 to 0.2 Mg;
0 to 0.25 Zn;
0 to 0.25 Cr;
0 to 0.15 Zr;
aluminum;
optionally, one or more incidental elements; and
impurities.

17. An article comprising:
the clad composite of claim 1; and
a fin coupled to the first layer of the clad composite, wherein the fin comprises a 1XXX series aluminum alloy or a 3XXX series aluminum alloy.

18. The article of claim 17, wherein the fin has a corrosion potential in a range of −740 mV to −900 mV.

19. (canceled)

20. (canceled)

21. A heat exchanger comprising a structural element comprising all or a portion of the article of claim 17.

22. (canceled)

23. A method for forming an article, the method comprising:
contacting a first part comprising a first material with a second part comprising all or a portion of the clad composite of claim 1; and
coupling the first part to the second part.

24. (canceled)

25. (canceled)

26. (canceled)
